(19) United States
(12) Patent Application Publication
(10) Pub. No.: US 2006/0046135 A1
(43) Pub. Date: Mar. 2, 2006

(54) Alkaline battery with MnO2/NiOOH active material

(76) Inventor: Weiwei Huang, Westlake, OH (US)

Correspondence Address: MICHAEL C. POPHAL;EVEREADY BATTERY COMPANY INC, 25225 DETROIT ROAD, P O BOX 450777, WESTLAKE, OH, 44145, US

(21) Appl. No.: 10/928,080

(22) Filed: Aug. 27, 2004

(51) Int. Cl. H01M 4/00; H01M 4/58; H01M 4/50

(52) U.S. Cl. 429/128; 429/224; 429/218.1

(57) ABSTRACT

The invention is an alkaline battery cell with a zinc anode and a cathode containing both nickel oxyhydroxide and manganese dioxide. The cell has high input capacity, as well as low polarization on high power discharge, to provide better high power discharge capacity and, at the same time, better low rate discharge capacity than a cell with just nickel oxyhydroxide as the cathode active material.

### BACKGROUND

This invention relates to an alkaline battery with a positive electrode having a blend of manganese dioxide and nickel oxyhydroxide as the active material.

Alkaline batteries, such as primary zinc/manganese dioxide batteries and rechargeable nickel batteries, are popular power sources for electronic devices, particularly portable devices. Electronic devices are often designed with limited space available for the batteries, restricting the number and size of batteries that can be used. For many types of devices there has been a general trend toward reducing the size of the battery compartment, while increasing the power requirements for operating the device.

Battery types such as lithium and lithium ion batteries can be advantageous in some devices because of their typically high energy densities and high voltages during use; however, they can be expensive compared to alkaline batteries because of high material costs and complex cell designs. Alkaline batteries can be less expensive and are therefore preferred for many types of devices. Rechargeable alkaline batteries can be advantageous in devices that require high battery power, since the cell designs for these battery types often have electrodes with high surface area to mass ratios, resulting in low electrode internal resistance and low discharge current density. However, such designs are still relatively expensive to manufacture. They also contain relatively large volumes of inactive materials, such as separators and current collectors, compared to primary alkaline cells with lower electrode interfacial surface to mass ratios, such as “bobbin” type designs, leaving less internal cell volume for active materials (therefore lower maximum discharge capacities) in the high electrode surface area cell designs. Low surface area electrode cell designs can have one electrode, frequently the positive electrode, formed into a shape (e.g., a hollow cylinder) with a cavity in which the other electrode is disposed. Examples of alkaline batteries with such designs include cylindrical zinc/manganese dioxide (Zn/MnO₂) LR03, LR6, LR14 and LR20 batteries, though other sizes of cylindrical batteries, as well as prismatic batteries with similar cell designs are also known and can be used for both primary and rechargeable batteries.

While alkaline batteries with bobbin type cell designs can be advantageous from a cost perspective and in discharge capacity at low to moderate discharge rates, performance on heavy drain, high rate and high power discharge (referred to below as high power discharge) can suffer. Modifications have been made to alkaline cells to improve high power discharge performance while attempting to minimize adverse effects on cost and low power discharge performance.

For example, primary alkaline Zn/MnO₂ batteries have been modified by replacing the MnO₂ (typically electrolytic manganese dioxide, or EMD) with other positive electrode active materials, such as NiOOH. NiOOH can be discharged at a higher, more constant voltage, providing an energy advantage in devices requiring high power and having high operating voltage. Examples of primary alkaline Zn/NiOOH cells are found in the following patent publications: JP 2003-017,079 A, JP 2003-017,080 A, JP 2003-257,423 A, U.S. Pat. No. 6,489,056 B1, U.S. Pat. No. 6,492,062 B1 and U.S. Pat. No. 6,566,009 B1, all of which disclose cells with bobbin type electrode configurations.

There are disadvantages to alkaline NiOOH cells as well. NiOOH is less dense than EMD, so less can be put into the same volume, and beta NiOOH cannot undergo more than a single electron reduction on discharge. This offsets the advantage of a higher, more uniform voltage on high power discharge and reduces the discharge capacity in lower power devices. NiOOH is also generally more expensive than EMD and has a tendency to self-discharge during cell storage, especially at high temperatures.

Attempts have been made to improve alkaline NiOOH cells in various ways to overcome the disadvantages. For example, NiOOH with different crystalline structures has been used, the nickel in the NiOOH has been partially substituted with a variety of ions (e.g., Zn, Co, Al, Ca, Mg, Ti, Sc, Fe, Mn, Y, Yb, Er, Cr, Li, Na, K, Rb, Cs, etc.), particles of NiOOH have been coated with various materials (e.g., graphite, metals, cobalt compounds, nickel compounds, etc.) and ranges of various characteristics of NiOOH (e.g., real density, tap density, particle size distribution and specific surface area) have been modified to increase the volumetric discharge capacity.

Blends of MnO₂ and NiOOH have also been used as the active material in alkaline cell positive electrodes, including cells with zinc as an active material in the negative electrodes, in some cases to offset disadvantages of all-MnO₂ or all-NiOOH positive electrodes. Examples of cells with MnO₂/NiOOH blends can be found in the following patent publications: EP 1,341,248 A1, EP 1,372,201 A1, JP 53-032,347 A, JP 56-015,555 A, JP 56-015,560 A, JP 56-054,759 A, JP 57-049,168 A, JP 2003-031,213 A, JP 2003-017,081 A, JP 2003-107,043 A, JP 2003-123,744 A, JP 2003-123,745 A, JP 2003-123,747 A, JP 2003-123,762 A, JP 2003-242,990 A, JP 2003-257,440 A, JP 2003-272,617 A, U.S. Pat. No. 4,405,698 A, U.S. Pat. No. 4,370,395 A, U.S. Pat. No. 6,566,009 B1, U.S. 2004/0043292 A1 and WO 03/67,689 A1.

To provide good discharge capacity, three desirable cell characteristics are high electrode capacity in the limiting electrode, low ohmic resistance and good ion diffusion. These characteristics are interrelated, and in practical cells changing one characteristic will generally change one or both of the others as well. The relative importance of these characteristics is different under different discharge conditions. For example, electrode capacity tends to be more important for lower power and intermittent discharge than for higher power and continuous discharge, and ohmic resistance and ion diffusion tend to be more important for higher power discharge. Consequently, it is common for cell designers to improve one or two of these three characteristics at the sacrifice of the other(s), depending on the anticipated discharge conditions. For batteries to be used under a variety of discharge conditions, the challenge is to provide good capacity under all of those anticipated conditions.

Polarization is an important parameter in determining cell capacity. Polarization is the departure of the potential from equilibrium condition caused by the passage of current. Polarization is related to discharge capacity and can be different under different discharge conditions. Three characteristics that contribute to total polarization are activation polarization, ohmic polarization and concentration polarization. Activation polarization is a measure of the change in potential due to the kinetic resistance of the electrochemical reactions on the surface of the active material, ohmic polarization is a measure of the change in potential due to a change in ohmic resistance and concentration polarization is a measure of the change in potential due to changes in the rates of diffusion of ions involved in the discharge reactions.

NiOOH has been substituted for EMD as a positive electrode active material in aqueous alkaline cells having a zinc as a negative electrode active material for batteries intended for use in device requiring a high operating voltage during high power discharge. This has typically been at the expense of capacity during lower rate discharge (e.g., lower power, lower current and lower resistance). Even in batteries where NiOOH and EMD have been combined as the positive electrode active material, lower rate discharge capacity has typically suffered. Therefore, a need still exists for further improvements in alkaline cells, and an object of the present invention is to provide an alkaline cell with good high power discharge capacity as well as good low to moderate discharge capacity. Another object of the invention is to provide an alkaline cell that is easily manufactured, particularly using manufacturing processes and equipment that are similar to those already in commercial use. A further object of the invention is to provide an economical alkaline cell with good high, moderate and low power discharge capacity.

### SUMMARY

The above objects are met and the above disadvantages of the prior art are overcome by an alkaline electrolyte cell with a blend of manganese dioxide and nickel oxyhydroxide as the positive electrode active material in which the amount of positive electrode active material is high, to give good discharge capacity at low discharge rates, while the discharge efficiency remains high to give good capacity on high power discharge.

Accordingly, in one aspect of the invention, an electrochemical battery cell comprises a positive electrode, a negative electrode, a separator between the positive and negative electrodes and an electrolyte disposed within a housing, wherein the positive electrode comprises a formed body comprising a mixture of solids including manganese dioxide and nickel oxyhydroxide in a ratio of 10/90 to 90/10 by weight, and the negative electrode comprises a mixture including zinc and is disposed within one or more cavities within the positive electrode body. When the positive electrode body comprises a single ring and has a volume of 3.3 to 4.6 cm³, the cell has a 1500 mW DSC polarization value of 100 to 310 mV; when the positive electrode body comprises a single ring and has volume of 1.4 to 2.0 cm³, the cell has a 1200 mW DSC polarization value of 100 to 310 mV; when the positive electrode body comprises a stack of two or more rings and has a volume of 3.3 to 4.6 cm³, the cell has a 1500 mW DSC polarization value of 100 to 240 mV; and when the positive electrode body comprises a stack of two or more rings and has a volume of 1.4 to 2.0 cm³, the cell has a 1200 mW DSC polarization value of 100 to 240 mV.

In a second aspect of the invention the electrochemical battery cell comprises a positive electrode, a negative electrode, a separator between the positive and negative electrodes and an electrolyte disposed within a housing, wherein the positive electrode comprises a formed body comprising a mixture of solids including manganese dioxide and nickel oxyhydroxide in a ratio of 10/90 to 90/10 by weight, and the negative electrode comprises a mixture including zinc and is disposed within one or more cavities within the positive electrode body. The positive electrode body comprises a single ring and has a volume of 3.3 to 4.6 cm³, the cell has a 1500 mW DSC polarization value of 100 to 310 mV and the cell has a discharge capacity of 2500 to 2800 mAh (preferably 2600 to 2800 mAh) when continuously cycled to 0.4 volt, where each cycle consists of 30 minutes at 50 mA followed by 2 hour open circuit.

In a third aspect of the invention the electrochemical battery cell comprises a positive electrode, a negative electrode, a separator between the positive and negative electrodes and an electrolyte disposed within a housing, wherein the positive electrode comprises a formed body comprising a mixture of solids including manganese dioxide and nickel oxyhydroxide in a ratio of 10/90 to 90/10 by weight, and the negative electrode comprises a mixture including zinc and is disposed within one or more cavities within the positive electrode body. The positive electrode body comprises a single ring and has a volume of 1.4 to 2.0 cm³, the cell has a 1200 mW DSC polarization value of 100 to 310 mV, and the cell has a discharge capacity of 1050 to 1250 mAh (preferably 1100 to 1250 mAh) when continuously cycled to 0.4 volt, where each cycle consists of 30 minutes at 50 mA followed by 2 hour open circuit.

In a fourth aspect of the invention the electrochemical battery cell comprises a positive electrode, a negative electrode, a separator between the positive and negative electrodes and an electrolyte disposed within a housing, wherein the positive electrode comprises a formed body comprising a mixture of solids including manganese dioxide and nickel oxyhydroxide in a ratio of 10/90 to 90/10 by weight, and the negative electrode comprises a mixture including zinc and is disposed within one or more cavities within the positive electrode body. The positive electrode body comprises a stack of two or more rings and has a volume of 3.3 to 4.6 cm³, the cell has a 1500 mW DSC polarization value of 100 to 240 mV, and the cell has a discharge capacity of 2600 to 2950 mAh (preferably 2700 to 2950 mAh) when continuously cycled to 0.4 volt, where each cycle consists of 30 minutes at 50 mA followed by 2 hour open circuit.

In a fifth aspect of the invention the electrochemical battery cell comprises a positive electrode, a negative electrode, a separator between the positive and negative electrodes and an electrolyte disposed within a housing, wherein the positive electrode comprises a formed body comprising a mixture of solids including manganese dioxide and nickel oxyhydroxide in a ratio of 10/90 to 90/10 by weight, and the negative electrode comprises a mixture including zinc and is disposed within one or more cavities within the positive electrode body. The positive electrode body comprises a stack of two or more rings and has a volume of 1.4 to 2.0 cm³, the cell has a 1200 mW DSC polarization value of 100 to 240 mV, and the cell has a discharge capacity of 1100 to 1300 mAh (preferably 1150 to 1300 mAh) when continuously cycled to 0.4 volt, where each cycle consists of 30 minutes at 50 mA followed by 2 hour open circuit.

In a sixth aspect of the invention the electrochemical battery cell comprises a positive electrode, a negative electrode, a separator between the positive and negative electrodes and an electrolyte disposed within a housing. The positive electrode comprises a hollow cylindrical body comprising a mixture of solids including manganese dioxide, nickel oxyhydroxide and graphite, where the ratio of manganese dioxide to nickel oxyhydroxide is 40/60 to 70/30 by weight and the ratio of the combination of manganese dioxide and nickel oxyhydroxide to graphite is 15/1 to 30/1 by weight. The positive electrode has a porosity of 17 to 23 volume percent and an electrical resistivity of 0.6 to 1.6 ohm-cm. The negative electrode is disposed within a cylindrical cavity within the positive electrode body and comprises a mixture including 62 to 70 weight percent zinc particles, the zinc being alloyed with bismuth, indium and aluminum, and the zinc particles having a median particle size of 110 to 120 μm. The negative electrode has a porosity of 70 to 76 volume percent and a resistivity of 3.5 to 3.8 milliohm-cm. The ratio of the negative electrode capacity to the positive electrode capacity is 1.15/1 to 1.25/1, and the electrolyte is an aqueous solution comprising 32 to 36 weight percent potassium hydroxide. In an embodiment in which the cell is an R6 size cell, the cell has a 1500 mW DSC polarization value of 100 to 225 mV; a discharge capacity of 2600 to 2950 mAh when continuously cycled to 0.4 volt, where each cycle consists of 30 minutes at 50 mA followed by 2 hour open circuit; and a discharge capacity of 800 to 1500 when cycled continuously to 1.05 volt, where each cycle consists of ten sets of alternating pulses of 1500 mW for 10 seconds then 650 mW for 28 seconds, followed by 55 minutes open circuit. In an embodiment in which the cell is an R03 size cell, the cell has a 1200 mW DSC polarization value of 100 to 225 mV; a discharge capacity of 1100 to 1300 mAh when continuously cycled to 0.4 volt, where each cycle consists of 30 minutes at 50 mA followed by 2 hour open circuit; and a discharge capacity of 300 to 700 mAh when cycled continuously to 1.05 volt, where each cycle consists of ten sets of alternating pulses of 1500 mW for 10 seconds then 650 mW for 28 seconds, followed by 55 minutes open circuit.

These and other features, advantages and objects of the present invention will be further understood and appreciated by those skilled in the art by reference to the following specification, claims and appended drawings.

Unless otherwise specified, the following definitions and methods are used herein:
(1) A/C ratio—the ratio of the electrode capacity of the negative electrode to the capacity of a the positive electrode in the cell;
(2) bobbin type electrode configuration—an arrangement of electrodes in which a mixture of the solid materials of one (e.g., the positive) electrode is formed into a solid body with one or more cavities within which the other (e.g., the negative) electrode is contained;
(3) capacity, discharge—the discharge capacity of a cell when discharged on a specified discharge test;
(4) capacity, electrode—a calculated capacity of the combined active materials in the electrode, determined by summing the measured specific capacity times the weight percent of the active material in the electrode; the electrode capacity can be expressed as a total capacity (e.g., in mAh) when the amount of electrode is known or as a specific capacity, either gravimetrically (e.g., in mAh/g) or volumetrically (e.g., in mAh/cm³);
(5) capacity, measured—a specific capacity of an active material is determined experimentally according to the electrochemical method described below;
(6) discharge efficiency—the ratio of a cell's discharge capacity on a specified discharge test to the smaller of the negative and positive electrode measured capacities;
(7) electrode body—that portion of an electrode that excludes any current collector;
(8) polarization of a cell—the departure of the cell voltage from equilibrium (open circuit) cell voltage caused by the passage of current; polarization includes ohmic polarization, activation polarization and concentration polarization, and is determined as described below;
(9) porosity—the portion of the of the volume of an electrode, excluding the current collector, that is not made up of solid materials (i.e., the inverse of the portion of the electrode volume that is made up of solid materials);
(10) solid materials—materials that do not have a significant solubility (i.e., a solubility less than 1 percent based on the weight of water) in the cell electrolyte; and
(11) solids packing—the tightness of the packing of the solid materials in a formed electrode, determined by dividing the sum of the volumes of all the solid materials in the electrode mixture by the total volume of the formed electrode mixture, where the volume of each solid material is determined by dividing the its weight by its real density, as determined by helium pychnometry or comparable method (solids packing is equal to 1 minus the porosity of the electrode).

Unless otherwise specified herein, all disclosed characteristics and ranges are as determined at room temperature (20-25° C.).

### BRIEF DESCRIPTION OF THE DRAWINGS

In the drawings:

FIG. 1 is a longitudinal cross-sectional view of an embodiment of an electrochemical battery cell of the invention.

### DESCRIPTION

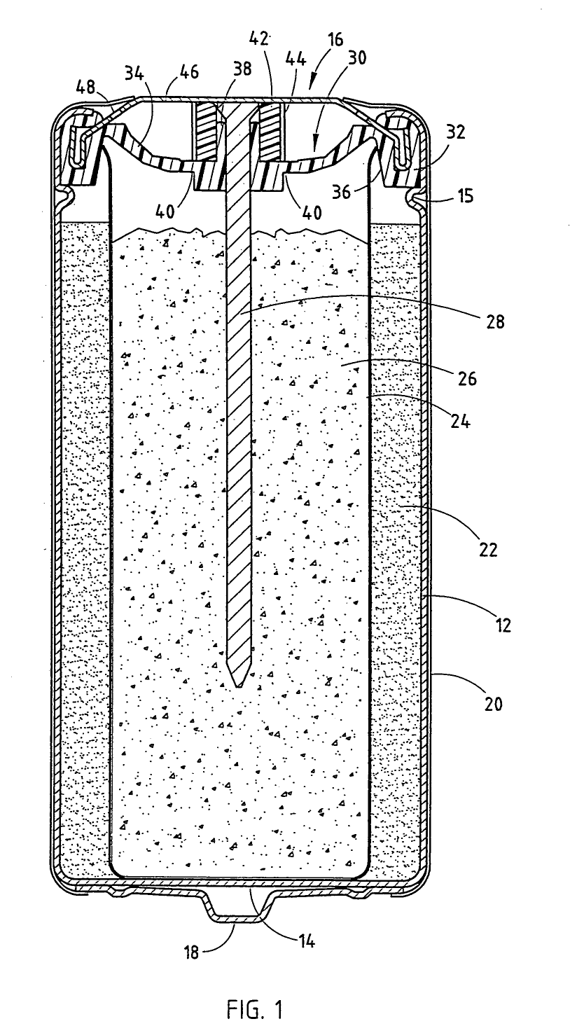

The invention will be better understood by reference to FIG. 1, which shows a cylindrical cell with a bobbin-type construction with dimensions comparable to a conventional LR6 (AA) size alkaline Zn/MnO₂ cell. However, cells according to the invention can have other sizes, shapes (such as prismatic) and electrode configurations (such as those disclosed in U.S. Pat. No. 5,869,205 (Feb. 9, 1999), U.S. Pat. No. 6,261,717 (Jul. 17, 2001), U.S. Pat. No. 6,342,317 (Jan. 29, 2002) and U.S. Pat. No. 6,410,187 (Jun. 25, 2002) and U.S. Patent Application Publication Nos. 2004/0058234 (Mar. 25, 2004) and 2004/0058235 (Mar. 25, 2004), the entire disclosures of which are incorporated by reference. The materials and designs for the components of the cell in FIG. 1 are for the purposes of illustration. Other suitable materials and designs may be substituted.

In FIG. 1, cell 10 includes a cylindrical steel can 12 having a closed bottom end 14 and an open top end 16. The closed bottom end 14 of can 12 includes a positive terminal cover 18 welded or otherwise attached thereto. The positive terminal cover 18 can be formed of plated steel, for example, with a protruding nub at its center region. A metalized, plastic film label 20 is formed about the exterior surface of the can 12, except for the ends of the can 12. Label 20 can be formed over the peripheral edges of the positive terminal cover 18 and can extend partially onto the negative terminal cover 46 as shown.

A positive electrode (cathode) 22 is formed about the interior surface of can 12 and has a generally hollow cylindrical shape. According to one example, the positive electrode 22 comprises a mixture including a blend of manganese dioxide (MnO₂) and nickel oxyhydroxide (NiOOH) as the active material, electrically conductive material, such as graphite, electrolyte solution, such as an aqueous potassium hydroxide (KOH) solution, and additives. The positive electrode mixture may be in contact with the interior surface of can 12 so that the can 12 serves as the positive electrode current collector. (As used herein, an electrode (positive or negative) does not include a current collector.)

A separator 24, which may include a cup-shaped separator and a tubular-shaped separator, is disposed about the interior surfaces of the positive electrode 22 and the can bottom 14.

A negative electrode (anode) 26 is disposed within the cavity formed by the positive electrode 22 and the can bottom 14. According to one example, the negative electrode 26 comprises a mixture including particulate zinc, a gelling agent and additives. Disposed in contact with the negative electrode 26 is a negative electrode current collector 28, which can be in the form of a nail with an enlarged head at one end.

The cell 10 is closed by a collector and seal assembly that closes the open end 16 of the can 12. The collector and seal assembly includes the negative electrode current collector 28, an annular seal 30 and a compression bushing 42, which can be preassembled and inserted into the open end 16 of the can 12 as a unit after the positive electrode 22, separator 24 and negative electrode 26 have been inserted into the can 12. An inwardly formed groove 15 in the can 12 near the open end 16 provides support for the collector and seal assembly. An outer negative cover 46 formed of plated steel, for example, is disposed over the collector and seal assembly, in contact with the negative electrode current collector 28, and serves as the negative contact terminal of the cell 10. The negative cover 46 includes one or more vent openings 48 that allow venting of gases from the cell 10 when the pressure release vent operates. The cell 10 is sealed by applying a radial force to the can 12 above the groove 15 to compress the upstanding seal wall 32 between the can 12 and the negative cover 46 and crimping the top edges of the can 12 and the upstanding seal wall 32 inward and downward to retain the negative cover 46 and collector and seal assembly in the open end 16 of the can 12.

The annular seal 30 has an outer peripheral upstanding wall 32, formed at its outer perimeter, and an inner upstanding wall, which forms a central thickened hub 38. Formed between the hub 38 and the outer upstanding wall 32 is an inwardly curved diaphragm 34 and an inverted V-section 36. The inverted V-section 36 forms a raised channel between the diaphragm 34 and the outer upstanding wall 32 for receiving the top open end of the separator 24. The central hub 38 defines an opening through which the current collector nail 28 extends, with the hub 38 providing an interference fit with the nail 28. A polymeric compression grommet 42 is force fitted around the hub 38 to compress the hub 38 radially inward. A sealant can be applied between the hub 38 and the nail 28. A sealant can also be applied between the upstanding wall 32 and the can 12. The seal 30 has a thinned section 40 formed in the diaphragm 38. The thinned section 40 is part of a pressure release vent that opens when pressure within the cell exceeds a predetermined level to relieve the internal pressure. At this point the thinned section 40 breaks to create an opening between the diaphragm 38 and the grommet 42 and allow pressurized gases to escape from the cell 10. Vertical channels 44 spaced around the perimeter of the grommet 42 insure a proper opening between the diaphragm 38 and the grommet 42.

The positive electrode includes a mixture of solid materials (solid mixture) which includes an active material and an electrically conductive material. The active material includes both manganese dioxide and nickel oxyhydroxide. Because the active material has a relatively high electrical resistivity, the solid mixture also contains particles of one or more materials with a high electrical conductivity to reduce the overall resistivity of the mixture. The solid mixture can contain an optional binder to hold the mixture together after it is formed into an electrode. The solid mixture can also contain other optional solid materials as well, such as lubricants and additives to enhance the electrical performance of the cell.

To provide good discharge capacity on both high power discharge and low rate discharge, aqueous alkaline cells according to the invention have a positive electrode active material comprising MnO₂ and NiOOH in a ratio of from about 10/90 to about 90/10 by weight. Because the capacities of MnO₂ and NiOOH are not the same, the relative amounts of these materials can also affect the capacity of the positive electrode mixture. Because the volumetric capacity of NiOOH is lower than that of electrolytic MnO₂, the capacity of a NiOOH electrode can be increased by substituting MnO₂ for some of the NiOOH. Preferably the ratio of MnO₂ to NiOOH is from about 20/80 to about 80/20, more preferably from about 30/70 to about 70/30 and most preferably from about 40/60 to about 70/30.

Simply adding MnO₂ to the positive electrode of an alkaline Zn/NiOOH cell does not assure that the cell will have improved low rate discharge capacity without sacrificing high power discharge capacity. In addition to adding MnO₂, the cell polarization must be sufficiently low on high power discharge. For example, for a cell with a positive electrode volume (excluding any current collector) of 3.3 to 4.6 cm², the total polarization of the cell on the high power 1500 mW/650 mW DSC test described below will be no greater than 240 mV (preferably no greater than 225 mV) when the positive electrode body comprises a stack of two or more rings and no greater than 310 mV (preferably no greater than 300 mV) when the positive electrode body comprises a single ring. For a cell with a positive electrode volume (excluding any current collector) of 1.4 to 2.0 cm², the total polarization of the cell on the high power 1200 mW/650 mW DSC test described below will be no greater than 240 mV (preferably no greater than 225 mV) when the positive electrode body comprises a stack of two or more rings and no greater than 310 mV (preferably no greater than 300 mV) when the positive electrode body comprises a single ring.

The total polarization of the cell and that of the individual electrodes can be modified by modifying the three components of polarization (activation, ohmic and concentration polarization) in various combinations.

Since the cell polarization is the drop in cell voltage caused by the passage of current, a cell's polarization value is dependent upon the magnitude and duration of the current. Of particular interest is polarization on high rate (e.g., high power) discharge. Two high power Digital Still Camera (DSC) tests have been selected for establishing cell polarization values for this invention. The first is referred to as the 1500 mW DSC test. On it a cell is discharged for ten cycles of 1500 mW for 2 seconds, then 650 mW for 28 seconds; the cell is then rested for 55 minutes; and this cycle/rest regimen is repeated continuously. The cell voltage is measured at the end of the last 1500 mW pulse before the total time on test reaches 20 minutes (i.e., at 19 minutes 32 seconds). The polarization value (1500 mW DSC polarization value) is the difference between this voltage and the cell equilibrium open circuit voltage (the maximum open circuit voltage to which the partially discharged cell will recover) at the time at which the cell voltage on discharge is measured. The second DSC test, referred to as the 1200 mW DSC test, is the same as the 1500 mW DSC test except that 1200 mW pulses are substituted for the 1500 mW pulses in the 1500 mW DSC test, and the polarization value (1200 mW DSC polarization value) is the difference between the voltage at the end of the last 1200 mW pulse before the total time on test reaches 20 minutes (i.e., at 19 minutes 32 seconds) and the equilibrium open circuit voltage at that point in the discharge.

Activation polarization is a function of the change in the driving force required to force the electrochemical discharge reaction to occur. This component of the total polarization is largely affected by the charge transfer kinetics of the electrochemical reaction of the active material.

Concentration polarization is a function of a change of ion diffusivity, porosity, tortuosity, etc., of the electrodes. An example of a way in which concentration polarization can be reduced is increasing the relative amount of liquid electrolyte within one or both electrodes (i.e., increasing the electrode porosity).

Ohmic polarization is a function of a change in ohmic resistance. Ohmic resistance can change as the active materials react during discharge, since reactants and reaction products typically have different electrical resistivities. Examples of ways in which the effects of changes in ohmic polarization can be reduced include reducing current density (e.g., by increasing the interfacial surface area between electrodes), increasing the relative amount of highly conductive material within or in contact with an electrode (e.g., the amount of graphite within the positive electrode mixture and the contact surface area between the positive electrode mixture and a current collector) and making the active material itself more electrically conductive (e.g., by coating the particles of active material with electrically conductive material).

Ohmic polarization is determined by a current interrupt method. Cell discharge is interrupted, measuring the cell voltage just prior to and at 200 microseconds after interrupting the discharge. The ohmic polarization is the difference between these two voltages.

Ohmic resistance is determined by dividing the ohmic polarization by the current at the time the closed circuit voltage was measured when determining the ohmic polarization. The ohmic resistance determined at the end of the 1500 mW pulse just prior to 20 minutes on the 1500 mW DSC test is referred to as the 1500 mW DSC ohmic resistance, and the ohmic resistance determined at the end of the 1200 mW pulse just prior to 20 minutes on the 1200 mW DSC test is referred to as the 1200 mW DSC ohmic resistance.

Concentration polarization, also referred to as concentration overpotential, is discussed in greater detail by Newman et al., Electrochemical Systems, third edition, John Wiley & Sons, Hoboken, N.J., USA, 2004.

The method of forming the positive electrode body can affect the ohmic resistance of the cell. Generally the ohmic resistance and polarization are lower when the positive electrode is formed using a ring molding process than when an impact molding process is used. For cells with a positive electrode volume of 3.3 to 4.6 cm³ (e.g., alkaline R6 size cells), when a ring molding process is used the 1500 mW DSC ohmic resistance value is preferably from 40 to 90 mΩ, and when an impact molding process is used the 1500 mW DSC ohmic resistance value is preferably from 75 to 130 mΩ. For cells with a positive electrode volume of 1.4 to 2.0 cm³ (e.g., alkaline R03 size cells), when a ring molding process is used the 1200 mW DSC ohmic resistance value is preferably from 55 to 110 mΩ, and when an impact molding process is used the 1200 mW DSC ohmic resistance value is preferably from 80 to 140 mΩ.

For good cell capacity on low power discharge, it is generally desirable to have a positive electrode with a high electrode capacity. Densely packing the solid mixture in the formed electrode contributes to high gravimetric and volumetric densities. The higher the solids packing is, the lower the porosity of the formed solid mixture will be, and the less electrolyte that can be contained therein. However, the higher the rate of discharge the greater the effects of polarization on discharge capacity will be, so higher porosities have generally been found to be desirable for good capacity on high power discharge. When the porosity of an electrode is low, the volume of electrolyte within the electrode is also low. This can contribute to high concentration polarization of the electrode. The electrolyte solution provides a medium through which ions move during discharge. Insufficient water can result in poor or slow ion mobility and high concentrations of electrolyte solute and reaction products. This situation is aggravated in cells according to the invention because water is consumed in the positive electrode discharge reactions. Even if there is sufficient water in the cell, if the electrode porosity is too low, water may not be able move quickly enough to the reaction sites where it is needed when the discharge rate is high. When the porosity is high, ohmic resistance and ohmic polarization may also be high. To provide good high power discharge capacity, the porosity of the positive electrode is preferably from 20 to 28, more preferably from 20 to 25, percent by volume; preferably the porosity of the negative electrode is from 70 to 78, more preferably from 70 to 76, percent by volume.

It has been found that limiting the solute concentration in the electrolyte helps maintain low concentration polarization in the positive electrode when the electrolyte volume is low, to provide good capacity on both low power and high power discharge. When the electrolyte solute comprises KOH, the preferred KOH concentration is at least 26 but less than 40 weight percent. If the concentration is below 26 percent, cell discharge capacity will be low because of higher anode concentration polarization, and if the concentration is above 40 percent, the positive electrode will become more polarized, reducing the cell voltage rapidly, on high power discharge. More preferably the KOH concentration is from 28 to 38 weight percent, and most preferably from 32 to 36 weight percent. If the KOH concentration is too low or too high, discharge efficiency decreases.

As described above, when the porosity of the formed solids mixture is low, the proportion of active materials in the electrode is high. Preferably the total amount of active material in the mixture will be from about 86 to about 97 percent of the total weight of solid materials. The percentage of active materials can also be kept high by using the minimum amounts of inactive materials. Preferably the amount of conductive material will be from about 3 to about 10 weight percent, and the amount of binder will be no more than about 1 weight percent. More preferably the amount of binder is no more than 0.65 percent, and yet more preferably no more than about 0.45 weight percent. The weight ratio of active material to conductive material is preferably from about 10/1 to about 30/1. If the amount of inert material is too great, the specific capacity of the electrode will be reduced. If the amount of binder is too great or the amount of conductive material is too small, the electrical resistivity of the mixture can be too high and the high power discharge capacity can be less than desired. If insufficient binder is included, the formed positive electrode can have less than the desired strength. The optimum amounts of conductive material and binder will depend in part on the characteristics of the specific materials selected, the cell manufacturing processes used and the final shape and dimensions of the formed positive electrode. In some embodiments the amount of graphite is about 4 to 8 weight percent, and in others it is about 5.5 to 6 weight percent.

The formed positive electrode body will have a relatively low electrical resistivity to provide good high power cell discharge performance. This is more important in cells where the positive electrode has a low ratio of current collector contact surface area to volume (i.e., where the positive electrode is relatively thick). For a cell with a bobbin-type rather than a spirally wound electrode configuration (e.g., one in which the negative electrode is disposed within one or more cavities in the positive electrode body), the electrical resistivity of the positive electrode will be less than about 10 ohm-cm, more preferably less than about 5 ohm-cm, and yet more preferably less than about 2.5 ohm-cm at room temperature. Most preferably the positive electrode will be about 0.6 to 1.6 ohm-cm. In addition to adding electrically conductive particles to the mixture, electrical resistivity can be reduced in other ways, such as by adding electrically conductive coatings to the particles of active materials, by doping the NiOOH with other cations, and by using a more electrically conductive binder.

The positive electrode resistivity can be determined using impedance spectroscopy, as described by R. Barnard et al., Journal of Applied Electrochemistry, 17, 165-183 (1987), according to the following method:
(1) drill a hole in the side wall of the cell container;
(2) insert a pipette type zinc reference electrode through the hole to the outer surface of the positive electrode (e.g., the surface contacting the cell container) and measure the depth of insertion;
(3) connect a frequency response analyzer (e.g., SOLARTRON® FRA Model 1250) coupled with a potentiostat (e.g., SOLARTRON® Model 1286 Potentiostat/Galvonostat) to both the reference electrode and the positive terminal of the cell;
(4) apply a small amplitude alternating current (e.g., 10 mV, to keep a linear response with the high signal to noise ratio of the system) over a frequency range of 1 to 65,000 Hz;
(5) from a Nyquist plot (imaginary component vs. real component of impedance) of the data from step (4), determine the electrical resistance value from the intersection of the plot with the real component axis at high frequency (greater than 1000 Hz);
(6) insert the reference electrode to the inner surface of the positive electrode (e.g., the surface in contact with the separator) and measure the depth of insertion;
(7) repeat steps (3) through (5); and
(8) divide the difference between the resistance values from step (5) by the difference in depth of insertion between steps (2) and (6).

The positive electrode mixture can be uniform in composition, or the composition can be non-uniform, such as one having different active material compositions, conductive material concentrations and different binder levels in different portions of the cathode. The cell can contain a single positive electrode structure, a composite structure (e.g., adjacent coaxial cylindrical structures having different compositions) or a multiple structure (e.g., with two coaxial formed positive electrodes).

Any suitable MnO₂ can be used as an active material component. Preferably the MnO₂ will be one that has a high theoretical specific capacity and discharges with a relatively high efficiency (i.e., has a high actual discharge capacity to theoretical specific capacity ratio) on high power discharge, such as an EMD. Preferably the EMD will contain no more than 200 parts per million of potassium impurities and have a potential of at least 0.860 volt vs. a standard hydrogen electrode at room temperature and a pH of 6.0, as disclosed in U.S. Pat. No. 6,589,693, issued Jul. 8, 2003, which is hereby incorporated by reference. Examples of suitable alkaline grade EMD are EMD from Kerr-McGee Chemical Corp., Oklahoma City, Okla., USA, and K60 grade EMD from Erachem Comilog, Inc., Baltimore, Md., USA.

EMD may also be treated in various ways (e.g., by doping with Ti, Zr or other ions or by coating the EMD particles with graphite or other materials) to improve the cell discharge performance. The MnO₂ component of the active material can include more than one type of MnO₂, each having different properties to affect cell performance in different ways.

Any suitable NiOOH can be used as an active material component, and combinations of NiOOH's with different compositions or characteristics can also be used. The NiOOH will be one that provides good discharge capacity in an alkaline cell and has good stability in the cell (e.g., is resistant to self-discharge, especially at high temperatures). Preferred characteristics of the NiOOH include a beta or gamma (more preferably beta) type crystalline structure, an average particle size of 13-40 (particularly 18-25) μm, a specific surface area (BET method) of about 12-40 (particularly 15-22) m²/g, a tap density of about 2.3 to 2.5 g/cm³ and particles coated with about 2-4 weight percent of a cobalt-containing material, particularly CoOOH. The NiOOH may be treated in various ways to improve cell performance. For example, a portion of the nickel may be substituted with one or more other cations and the surface of NiOOH particles is coated with a very conductive layer such as CoOOH. It may also be desirable to use a NiOOH with a limited open circuit potential, such as one with a midlife voltage less than about 1.76, or even less than about 1.72, when measured against zinc in a 40 weight percent KOH solution with 3 weight percent ZnO added. Examples of NiOOH that can be used in alkaline cells can be obtained from Tanaka Chemical Co. (Fukui, Japan), Kansai Catalyst Co., Ltd (Osaka, Japan), Umicore Canada Inc. (Leduc, Alberta).

Any suitable conductive material or combination of conductive materials can be used in the positive electrode mixture. Examples including but are not limited to graphite, graphitized carbon and metal. The particles of conductive material can be in any suitable shape, such as spherical and non-spherical powders, flakes, hollow tubes, whiskers and the like. The conductive material will be stable within the cell. Preferably the conductive material will be a material that provides the desired low level of resistivity to the positive electrode mixture with a minimum added volume. However, other factors, such as the desired solids packing level, the positive electrode forming process and the desired formed electrode strength will also be considered in selecting a conductive material. Graphite is a suitable type of conductive material for use in alkaline cells with a MnO₂/NiOOH active material. Graphite can be synthetic or natural graphite. It can be expanded, preferably with a kerosene absorption value of 2.2 to 3.5 ml/g, as disclosed in co-pending U.S. patent application Ser. No. 09/213,544, filed Dec. 17, 1998 (corresponding to International Patent Publication No. WO 99/34,673 dated Jul. 15, 1999), which is hereby incorporated by reference, it can be non-expanded, or it can be a mixture of expanded and non-expanded graphites. Examples of suitable non-expanded graphites are KS-6 grade graphite from TIMCAL America, Westlake, Ohio, USA, and MX25 grade synthetic graphite from Lonza, Ltd., Basel, Switzerland. An example of a suitable expanded graphite is GA-17 grade expanded graphite from Superior Graphite Co., Chicago, Ill., USA.

If graphite is used as a conductive material, using expanded graphite can reduce the amount of graphite required; however, expanded graphite is more expensive, so it may be preferable to use a blend of expanded and non-expanded graphite to achieve the minimum positive electrode mixture resistivity desired while minimizing cost. For example if the ratio of active material to graphite is no more than 15/1 by weight, it may not be necessary to use any expanded graphite, and if the active material to graphite ratio is 30/1 or higher, it may be necessary to use 100 percent expanded graphite in order to achieved the desired positive electrode electrical resistivity.

If a binder is desired, any suitable binder can be used. Examples include polytetrafluoroethylene, such as contained in grade TFE 30B dispersion from E.I. du Pont de Nemours & Co., Polymer Products Div., Wilmington, Del., USA; polyethylene, such as COATHYLENE® HA 1681 from Clariant Corp., Warren, N.J., USA; a diblock copolymer of styrene, ethylene and propylene, such as KRATON® G1702 from Kraton Polymers Business, Houston, Tex., USA; polyvinylidene fluoride; polyacrylamide; and Portland cement. As described above, it may be preferable to use a minimum amount of binder to allow a higher proportion of active materials and/or more conductive materials. However, if the binder also serves another purpose in the cell, such as providing reduced electrical resistivity (e.g., if the binder is an electrically conductive polymer) or improved ionic conductivity, it may be desirable to use more than the minimum amount required to provide the desired strength to the formed positive electrode.

Small quantities of other materials can be added to the positive electrode mixture. A lubricant such as stearic acid is an example of a material that can be added to improve positive electrode forming process. Performance enhancing additives can also be included; examples include titanium oxides, such as rutile and anatase TiO₂, n-type titanium dioxides, such as reduced and niobium doped titanium dioxides, and titanates such as barium titanate. Solid materials that have higher oxidizing potential than NiOOH (e.g., BaFeO₄ and AgO) can also be included as additives in the positive electrode mixture.

The positive electrode mixture can be formed into the desired shape using any suitable process. Two processes that have been used to form cylindrical alkaline Zn/MnO₂ bobbin type cells can be adapted to form positive electrodes according to the invention: impact molding and ring molding.

The packing of the solid materials in the formed positive electrode mixture can depend in part upon the forming process. Using an impact molding process it is difficult to achieve more than about 74 percent solids packing (or less than 26 percent porosity) on a volumetric basis. Preferably the minimum solids packing is 69 percent (corresponding to a maximum of 31 percent porosity), more preferably the solids packing is at least 71 percent (a maximum of 29 percent porosity), and most preferably the solids packing is at least 73 percent (a maximum of 27 percent porosity). Using a ring molding process, up to 83 percent or more solids packing (corresponding to 17 percent porosity) can be achieved. Preferably the solids packing is at least 70 percent (a maximum of 30 percent porosity), more preferably the solids packing is at least 77 percent (a maximum of 23 percent porosity), and most preferably the solids packing is at least 79 percent (a maximum of 21 percent porosity).

In impact molding the desired amount of positive electrode mixture is inserted into the lower portion of the can, and a ram with an outside diameter approximately equal to the desired inside diameter of the central cavity in the formed positive electrode is inserted into the center of the cell, forcing cathode outward against the inside surface of the can side wall and upward to a desired height. For high, consistent solids packing, it is preferable to constrain the top of the mixture during at least the latter portion of the impact molding process.

In ring molded cells two or more (usually 3 to 5) hollow cylindrical rings are formed and inserted into the can in a stack (one on top of another). The outside diameter of the rings may be slightly greater than the inside diameter of the can to produce an interference fit with good physical and electrical contact between the positive electrode mixture and the can. Alternatively, the formed rings may be slightly smaller than the can to facilitate insertion into the can without damage, followed by the application of an axial and/or radial force against the top and/or inside diameter of the rings to force the mixture firmly against each other and against the inside surface of the can.

In an embodiment of the invention the cell has a ring molded cathode having an active material consisting essentially of MnO₂ (preferably EMD) and NiOOH. The preferred cathode capacity density (cathode capacity per unit of formed cathode volume) is within the range defined by the formula ax+b, where x is the weight percent MnO₂ in the cathode active material, a is 1.8 mAh/cm³ and b is 553 to 698 mAh/cm³. For example, when the active material is 50 weight percent MnO₂, the preferred capacity density of the cathode will be 643 to 788 mAh/cm³.

Because of process differences, the preferred ratio of active material to conductive material can range from about 10/1 to 20/1 by weight with impact molding and from about 15/1 to 30/1 with ring molding.

When the cell is fully assembled the positive electrode will also contain electrolyte. A portion of this electrolyte can be mixed with the solid materials of the positive electrode mixture prior to forming the positive electrode. After the positive electrode is formed, a portion of the electrolyte can be added directly to the positive electrode. The remainder of the electrolyte migrates into the positive electrode from the negative electrode and the separator. Initially, and during cell discharge, the amount, distribution and composition of electrolyte within the positive electrode can vary, but after cell manufacture and during periods of rest (no discharge), the electrolyte within the positive electrode tends to move to an equilibrium condition, in which the electrolyte composition is uniform throughout the cell. Unless otherwise indicated below, the electrolyte composition is assumed to be uniform.

Most of the electrolyte can be added to the cell as part of the negative electrode mixture, which also includes an active material, such as zinc, zinc alloys, magnesium, and magnesium alloys. When the active material includes particulate zinc, the active material and electrolyte can be mixed in a flowable mixture that can be pumped or otherwise dispensed into the cell. The electrolyte can also include a gelling agent that causes the electrolyte to gel, suspending the particulate active material therein, after the anode mixture is dispensed.

For an alkaline cell according to the invention having a gelled negative electrode comprising a particulate zinc-containing active material, the composition of the negative electrode mixture in the completed cell can be about 60 to 73 weight percent zinc particles, about 26.5 to 38.5 weight percent electrolyte and about 0.3 to 0.7 weight percent gelling agent. Small amounts of other materials can be included in the negative electrode, as described in more detail below. Preferably the zinc content in the negative electrode is at least 62 weight percent. Preferably the zinc content in the negative electrode is no more than 73 weight percent and more preferably no more than 71 weight percent. If the percentage of zinc is too high electrolyte diffusion within the electrode can limit the high power discharge performance of the cell. A high level of zinc can also result in excessive hydrogen gassing and cell leakage, particularly after deep discharge. This is particularly true for cells with a positive electrode active material comprising MnO₂ and NiOOH, since the capacity density of NiOOH is much lower than that of EMD. If the percentage of zinc in the negative electrode is too low, there can be an inadequate electrically conductive matrix of zinc particles in the negative electrode, isolating some of the zinc particles and causing incomplete utilization of the zinc during cell discharge.

The electrical resistivity of the solid matrix of the negative electrode in the cell as manufactured is less than about 10, more preferably less than about 4, milliohm-cm. Most preferably the negative electrode resistivity is 3.5 to 4.0, particularly 3.5 to 3.8, milliohm-cm.

The resistivity of the negative electrode is determined by the method disclosed in co-pending U.S. Patent Application Ser. No. 10/713,833, filed Nov. 14, 2003, which hereby incorporated by reference:
(1) fill an electrically nonconductive tube having a constant diameter and a known length (L) with anode mixture;
(2) place a copper plate as a current collector at each end of the tube;
(3) connect a frequency response analyzer (e.g., SOLARTRON® FRA Model 1250) coupled with a potentiostat (e.g., SOLARTRON® Model 1286 Potentiostat/Galvonostat) to the copper current collectors;
(4) apply a small amplitude alternating current (e.g., 10 mV, to keep a linear response with the high signal to noise ratio of the system) over a frequency range of 1 to 65,000 Hz;
(5) from a Nyquist plot (imaginary component vs. real component of impedance) of the data from step (4), determine the electrical resistance value from the intersection of the plot with the real component axis at high frequency (greater than 1000 Hz); and
(6) Calculate the resistivity using the formula: Resistivity=Resistance•(S/L), where S=π(D/2)².

Any suitable zinc material can be used. Preferably the zinc composition is a high purity (e.g., at least 99.8 weight percent zinc), low-gassing composition, especially for use in cells with no added mercury. The zinc particles can be in a variety of shapes and sizes, selected to provide good discharge performance and a good electrical matrix within the negative electrode at a reasonable cost. Examples of zinc shapes that can be used include spherical and non-spherical powders and flakes.

Preferably the zinc material will be a low gel expansion zinc, as disclosed in U.S. Pat. No. 5,464,709, issued Nov. 7, 1995, which is hereby incorporated by reference. Examples of preferred zinc materials are grades BIA 110 and BIA 115 zinc alloy powders from N.V. UMICORE, S.A., Brussels, Belgium. These materials comprise a zinc alloy with bismuth, indium and aluminum incorporated therein, preferably containing 75 to 125 parts per million (ppm) bismuth, 175 to 225 ppm indium and 75 to 125 ppm aluminum. The composition of the BIA zinc alloy and the centrifugal atomization process used to manufacture these materials are described in International Patent Publication No. WO 00/48260, dated Aug. 17, 2000. To provide good zinc particle-to-particle contact within the negative electrode at relatively low (e.g., 28 volume percent and lower) zinc concentrations, BIA 115 zinc has the characteristics disclosed in copending U.S. patent application Ser. No. 10/713,833, filed Nov. 14, 2003, which is hereby incorporated by reference. These characteristics include a particle size characterized as having a median value (D50) less than 130 μm (more preferably between 100 and 130 μm and most preferably between 110 and 120 μm), a BET specific surface area of at least 400 cm²/g (more preferably at least 450 cm²/g), a tap density greater than 2.80 g/cm³ and less than 3.65 g/cm³ (more preferably greater than 2.90 g/cm³ and less than 3.55 g/cm³ and most preferably greater than 3.00 g/cm³ and less than 3.45 g/cm³) and a KOH absorption value of at least 14 percent (preferably at least 15 percent).

Zinc materials comprising zinc flakes and agglomerated fine zinc powders can also be used, either alone or in combinations with zinc materials having other morphologies. Zinc flakes are available from manufacturers such as Transmet Corporation of Columbus, Ohio, USA, and Eckart-PM-Laboratory, Vetroz, Switzerland. An example of agglomerated zinc particles is disclosed in U.S. Pat. No. 6,300,011 B1, issued Oct. 10, 2001, which is hereby incorporated by reference, and U.S. Patent Publication No. 2004/0013940 A1, which is also hereby incorporated by reference, discloses a cell having a negative electrode comprising a mixture of agglomerated and nonagglomerated zinc particles.

Gassing inhibitors, organic and inorganic anticorrosive agents and surfactants can be added to the negative electrode. Examples of gassing inhibitors and anticorrosive agents include indium salts (e.g., In(OH)₃), perfluoroalkyl ammonium salts and alkali metal sulfides. Examples of surfactants include polyethylene oxide, polyethylene alkylethers and perfluoroalkyl compounds. Adding zinc oxide can also prevent gassing.

The negative electrode mixture can also include a rheological modifier to improve processing of the mixture in cell manufacturing, as disclosed in copending U.S. Patent Application No. 734518, filed Dec. 12, 2003, which is hereby incorporated by reference. Examples of Theological modifiers include nonylphenol ethoxylate phosphates such as STEPFAC® 8173 and STEPFAC® 8170 from Stepan Chemicals, Northfield, Ill., USA, QS-44® from Dow Chemical, Midland, Mich., USA, and surfactants such as DISPERBYK® 190 and DISPERBYK® 102 from BYK Chemie, Germany.

Suitable gelling agents include carboxymethylcellulose, polyacrylamide and sodium polyacrylate. A preferred gelling agent is a crosslinked polyacrylic acid, such as CARBOPOL® 940 from Noveon, Inc., Cleveland, Ohio, USA.

Preferably a cell according to the invention with a positive electrode active material comprising both EMD and NiOOH has a ratio of the negative electrode capacity to the positive electrode capacity (referred to below as the anode to cathode ratio, or A/C ratio) from about 1.0 to 1.4, more preferably no more than 1.35, to prevent electrolyte leakage cell after deep discharge.

For a cell with a given cathode capacity, higher A/C ratios can be advantageous in maximizing discharge capacity. In general, the higher the EMD to NiOOH ratio, the higher the A/C can be without electrolyte leakage on deep discharge. This may be because Mn⁺⁴ can be reduced farther beyond the first electron reduction (to MnOOH) than Ni⁺³ can be reduced beyond the average valence of its nominal reaction product (Ni(OH)₂), so gassing on deep discharge is less of a concern for cells with higher percent of EMD in the cathode. Additionally, cathode discharge may be more efficient at low rates for cells made using impact molding process. Therefore, when the weight ratio of NiOOH to EMD is from 40/60 to 80/20, an A/C ratio of about 1.15 to 1.25 is preferred for ring molded cells, and for impact molded cells an A/C ratio of about 1.20 to 1.35 is preferred.

The electrode capacities are based on the measured capacities of their respective active materials. The measured capacity of alkaline battery grade zincs vary little and is typically very close to theoretical capacity of 820 mAh/g, which is used herein as the measured capacity of zinc. The measured capacities of the positive electrode active materials are determined using an intermittent low rate discharge to a specified cut off voltage. A positive electrode, consisting of 82.59 weight percent active material, 13.76 weight percent graphite, 0.65 weight percent polyethylene binder and 3.00 weight percent aqueous KOH (40 weight percent) solution, is compressed into an thin (about 0.13 to 0.15 mm) electrode about 19 mm in diameter. The electrode is discharged with a repeating discharge cycle of 10 mA per gram of electrode material for 30 minutes followed by 2 hours open circuit in a 40 weight percent KOH solution nearly saturated with ZnO against a zinc reference electrode (zinc in an electrolyte of 40 weight percent KOH and 3 weight percent ZnO) to 1.0 V for NiOOH electrode and 0.9 V for EMD.

The separator used in the invention is electrically nonconductive and permeable to the electrolyte. The separator can be a single layer or it can comprise multiple layers, either separate or laminated together. When two layers are used, both can be made from the same material, or the layers can be made from different materials, such as different grades of the same type of material or different types of material. Suitable types of separator material can be woven and non-woven types, made from materials such as cellulose, polyvinyl alcohol, rayon and cellophane. Examples include a separator made from nonwoven, fibrillated cellulose fibers (as disclosed in U.S. Patent Publication No. 2003/0096171 A1, dated May 22, 2003, which is hereby incorporated by reference), available from Carl Freudenberg KG, Weinheim, Germany; VLZ 105 grade separator from Nippon Kodoshi Corp., Kochi-ken, Japan; PA25 grade polyvinyl alcohol and rayon from PDM; and fibrous cellulose paper impregnated with a polymer solution (as disclosed in U.S. Pat. No. 6,670,077 B1, issued Dec. 30, 2003, which is hereby incorporated by reference). Alternatively, the separator can be made from or include a layer of poly (acrylic acid-co-sodium-4-styrene sulfonate), which can be applied to a substrate or directly to the surface of the positive electrode.

The negative electrode current collector can be of any material and design that are suitable for use in the cell of the invention. The design and materials can be selected to minimize the generation of gas during normal storage and use of the cell as well as under abnormal conditions, especially when the cell contains little or no added mercury. For example, the negative electrode current collector for a cell with zinc as a negative electrode active material and an aqueous KOH electrolyte can be made from brass coated with indium or tin. The design of the current collector will depend in part on the overall cell design. In a cylindrical cell with a bobbin type electrode configuration, for example, the current collector can be in the form of a nail or pin that is in electrical contact with the negative contact terminal of the cell and extends into the negative electrode.

The container may be a can made of steel and it may serve as a current collector for the positive electrode formed against its inside surface. The steel may be plated on the inside surface with nickel and/or cobalt, and a coating containing carbon (e.g., graphite) can be applied to the can surface to improve electrical contact with the electrode. Suitable graphite coatings include LB1000 and LB1090 (TIMCAL America, Ltd., Westlake, Ohio, USA), ECCOCOAT® 257 (W.R. Grace & Co.), and ELECTRODAG® 109 and 112 (Acheson Colloids Company, Port Huron, Mich., USA).

The open end(s) of the container can be closed with a collector and seal assembly. Preferably the assembly will take up a small volume within the cell to allow a large volume for active materials and electrolyte. The collector and seal assembly can have a design similar to that of cell 10 in FIG. 1. Other suitable designs can be used. Examples are disclosed in U.S. Pat. No. 6,312,850 (issued Nov. 6, 2001), U.S. Pat. No. 6,270,918 (issued Aug. 7, 2001), U.S. Pat. No. 6,265,101 (issued Jul. 24, 2001), U.S. Pat. No. 6,087,041 (issued Jul. 11, 2000), and U.S. Pat. No. 6,060,192 (issued May 9, 2000); U.S. Patent Publication No. 2003/0157398 (published Aug. 21, 2003); and copending U.S. patent application Ser. No. 10/439,096 (filed May 15, 2003) and Ser. No. 10/365,197 (filed Feb. 11, 2003), all of which are hereby incorporated by reference.

The cell can have a pressure release vent mechanism to release pressure from within the cell when the pressure exceeds a predetermined value. The vent mechanism can be incorporated into the seal member in the collector and seal assembly, as shown in FIG. 1, or it can be incorporated elsewhere, such as in a cell cover or in a side or bottom wall of the container.

Cells made according to the invention can be used in single or multiple cell batteries. The cells can be generally cylindrical, or they can have other shapes, such as prismatic.

In a preferred embodiment of the invention, the cell is hermetically sealed. In other words, internal cell components are not intended to be open to the air either during storage or use, such as in metal/air, air-assisted and fuel cells. In another preferred embodiment the cell is a primary cell, not intended to be recharged.

Embodiments of the invention are described in detail and compared to conventional cells in the following examples.

### EXAMPLE 1

Comparative LR6 type alkaline Zn/MnO₂ cells (identified below as Lots 1 and 2) were made with only MnO₂ as the active material. Comparative R6 size alkaline Zn/NiOOH cells (identified below as Lot 3) were made with only NiOOH as the active material. The cells in both lots were similar to those of cell 10 in FIG. 1. Features of the completed cells are summarized in Table 1. The materials used in Lot 3 were the same as those in Lots 1 and 2, except NiOOH was used as the active material instead of EMD.

The EMD used for Lots 1 and 2 was alkaline battery grade EMD from Kerr-McGee. The NiOOH used for Lot 2 was obtained from Umicore. The graphite was expanded graphite with a kerosene absorption value of 2.2 to 3.5 ml/g. The zinc was a bismuth-indium-aluminum alloy with a median particle size of 115 μm.

The compositions of the cathode, anode and electrolyte listed in Table 1 are for the final cell unless otherwise indicated. The cathode mixture composition shown does not include the electrolyte that is contained therein; the anode mixture composition shown is for the anode before adding it to the cell. Additional liquid is also added to the cell, and its composition is also shown. The final electrolyte amount and KOH concentration is for the cell after assembly and includes the water and KOH that are added to the cell as part of the cathode, the anode and additional liquid.

The cathodes for Lots 1 and 3 were formed using a ring molding process, and impact molding was used for Lot 2. The cathode mixture dry ingredients were mixed with aqueous 40 weight percent KOH solution (1.5 to 3 weight percent for ring molded cells and 5 to 7 weight percent for impact molded cells) before molding.

Anode mixture was prepared with the composition shown in Table 1 and added to the cells. For cells with ring molded cathodes, the electrolyte solution contained 33 weight percent KOH, 1 weight percent ZnO and 0.3 weight percent sodium silicate; for cells with impact molded cathodes, the electrolyte solution contained 32 weight percent KOH, 1 weight percent ZnO and 0.3 weight percent sodium silicate.

Additional water and KOH were added to the cell at various stages of the assembly process.

Electrode and cell characteristics are summarized in Table 1. In the table, “dry” includes only the solid ingredients in the cathode mixture (listed under “cathode mixture composition”), “wet” includes solid ingredients as well as water and water soluble materials added to the cathode mixture during the cathode mixing process (before the cathode is formed) and “final” characteristics are those for the completed cell at equilibrium.

TABLE 1

| | Lot 1 | | Lot 2 | | Lot 3 | |
|---|---|---|---|---|---|---|
| Cathode solids mixture: | | | | | | |
| EMD | 94.78 | wt % | 93.1 | wt % | 0.0 | wt % |
| NiOOH | 0.0 | wt % | 0.0 | wt % | 94.77 | wt % |
| graphite | 4.75 | wt % | 6.9 | wt % | 4.76 | wt % |
| binder | 0.47 | wt % | 0.0 | wt % | 0.47 | wt % |
| EMD/NiOOH (by wt) | 100/0 | | 100/0 | | 0/100 | |
| active material/graphite (by wt) | 20/1 | | 13/1 | | 20/1 | |
| Cathode solids mixture quantity (dry) | 11.20 | g | 10.74 | g | 11.44 | g |
| Cathode mixture quantity (wet) | 12.37 | g | 12.13 | g | 12.35 | g |
| Cathode forming process | ring molded | | impact molded | | ring molded | |
| Cathode dimensions (final): | | | | | | |
| outside diameter | 13.49 | mm | 13.51 | mm | 13.49 | mm |
| inside diameter | 8.84 | mm | 8.76 | mm | 8.84 | mm |
| height | 43.54 | mm | 43.51 | mm | 43.54 | mm |
| volume | 3.55 | cm³ | 3.62 | cm³ | 3.55 | cm³ |
| Cathode porosity (final) | 24.5% | | 29.0% | | 19.2% | |
| Cathode resistivity (final) | 1.7 | ohm-cm | — | | 1.0 | ohm-cm |
| Cathode capacity | 3030 | mAh | 2850 | mAh | 2330 | mAh |
| Cathode volumetric capacity (final) | 854 | mAh/cm³ | 788 | mAh/cm³ | 657 | mAh/cm³ |
| Cathode gravimetric capacity (dry) | 245 | mAh/g | 235 | mAh/g | 189 | mAh/g |
| Anode composition (pre-assembly): | | | | | | |
| zinc | 68.00 | wt % | 71.22 | wt % | 61.00 | wt % |
| electrolyte solution | 31.55 | wt % | 28.39 | wt % | 38.45 | wt % |
| gellant | 0.45 | wt % | 0.39 | wt % | 0.55 | wt % |
| Zinc quantity | 4.37 | g | 4.51 | g | 3.48 | g |
| Anode capacity | 3584 | mAh/g | 3700 | mAh/g | 2860 | mAh/g |
| Anode porosity (final) | 71.8% | | 70.9% | | 77.5% | |
| Anode resistivity (final) | 3.7 | mohm-cm | 3.7 | mohm-cm | 3.7 | mohm-cm |
| Electrolyte (final - total cell): | | | | | | |
| water | 66.6 | wt % | 65.2 | wt % | 64.3 | wt % |
| KOH | 32.9 | wt % | 34.3 | wt % | 35.1 | wt % |

| | | | |
|---|---|---|---|
| A/C ratio | 1.18/1 | 1.30/1 | 1.23/1 |

### EXAMPLE 2

R6 size alkaline cells (identified below as Lots 4 and 5) were made with blends of MnO₂ and NiOOH as the active material. The cells were made with the same material types and the same processes as in Example 1 and were similar to the cells in Lots 1, 2 and 3, except as shown in Table 2. The positive electrodes for Lot 4 were ring molded and those for Lot 5 were impact molded.

TABLE 2

| | Lot 4 | | Lot 5 | |
|---|---|---|---|---|
| Cathode solids mixture: | | | | |
| EMD | 47.02 | wt % | 60.1 | wt % |
| NiOOH | 47.75 | wt % | 32.9 | wt % |
| graphite | 4.77 | wt % | 7.0 | wt % |
| binder | 0.47 | wt % | 0.0 | wt % |
| EMD/NiOOH (by wt) | 50/50 | | 65/35 | |
| active material/graphite (by wt) | 20/1 | | 13.3/1 | |
| Cathode solids mixture quantity | 11.32 | g | 10.96 | g |
| (dry) | | | | |
| Cathode mixture quantity (wet) | 12.36 | g | 12.23 | g |

| | | |
|---|---|---|
| Cathode forming process | ring molded | impact molded |

Cathode dimensions (final):

| outside diameter | 13.49 | mm | 13.51 | mm |
|---|---|---|---|---|
| inside diameter | 8.84 | mm | 8.76 | mm |
| height | 43.54 | mm | 43.51 | mm |
| volume | 3.55 | cm³ | 3.62 | cm³ |
| Cathode porosity (final) | 22.0% | | 26.4% | |
| Cathode resistivity (final) | 0.97 | ohm-cm | — | |
| Cathode capacity | 2679 | mAh | 2654 | mAh |
| Cathode volumetric capacity (final) | 755 | mAh/cm³ | 734 | mAh/cm³ |
| Cathode gravimetric capacity (dry) | 217 | mAh/g | 217 | mAh/g |
| Anode composition | | | | |
| (pre-assembly): | | | | |
| zinc | 64.80 | wt % | 69.07 | wt % |
| electrolyte solution | 34.71 | wt % | 30.51 | wt % |
| gellant | 0.49 | wt % | 0.42 | wt % |
| Zinc quantity | 3.93 | g | 4.20 | g |
| Anode capacity | 3230 | mAh/g | 3450 | mAh/g |
| Anode porosity (final) | 74.6% | | 71.0% | |
| Anode resistivity (final) | 3.7 | mohm-cm | 3.7 | mohm-cm |
| Electrolyte (final - total cell): | | | | |
| water | 65.4 | wt % | 66.5 | wt % |
| KOH | 34.1 | wt % | 33.0 | wt % |

| | | |
|---|---|---|
| A/C ratio | 1.21/1 | 1.30/1 |

### EXAMPLE 3

Cells from each of Lots 1 through 5 were discharged on a low rate discharge test and on a high power discharge test at room temperature. The low rate and high power discharge tests are described below. Cells from each lot were also tested on the 1500 mW DSC test to determine cell polarization, concentration polarization, activation polarization, ohmic polarization and ohmic resistance as described above. The results are summarized in Table 3.

The low rate discharge test is an intermittent constant current test consisting of cycles of 50 mA for 30 minutes followed by 2 hours open circuit, repeated continuously until the cell reaches 0.4 volt.

The high power test is a Digital Still Camera (DSC) test. A cell is discharged for ten cycles of 1500 mW for 2 seconds followed by 650 mW for 28 seconds; the cell is then rested for 55 minutes. This cycle/rest regimen is repeated continuously until the cell voltage reaches 1.05 V.

TABLE 3

| | Lot 1 | Lot 2 | Lot 3 | Lot 4 | Lot 5 |
|---|---|---|---|---|---|
| EMD/NiOOH | 100/0 | 100/0 | 0/100 | 50/50 | 65/35 |
| (by weight) | | | | | |
| cathode molding process | ring | impact | ring | ring | impact |
| cathode capacity (mAh) | 3030 | 2850 | 2330 | 2679 | 2654 |
| low rate discharge capacity | 3009 | — | 2500 | 2726 | — |
| (mAh) | | | | | |
| high power discharge capacity | 516 | 255 | 963 | 1132 | 771 |
| (mAh) | | | | | |
| high power discharge efficiency | 17 | 9 | 39 | 42 | 29 |
| (%) | | | | | |
| ohmic resistance (mΩ) | 62 | 99 | 70 | 54 | 95 |
| ohmic polarization (mV) | 75 | 129 | 71 | 54 | 100 |
| activation polarization (mV) | 16 | 31 | 12 | 13 | 20 |
| concentration polarization (mA) | 165 | 212 | 128 | 144 | 163 |
| total cell polarization (mV) | 256 | 372 | 211 | 212 | 283 |

For cells with ring molded cathodes, a comparison of Lots 1 and 3 shows that replacing EMD with NiOOH in the cathode, while increasing discharge capacity on the high power (DSC) test by about 87 percent, results in a 17 percent reduction in discharge capacity on the low rate discharge test. When a 50/50 blend of EMD and NiOOH was used as the active material (Lot 4), the reduction in low rate discharge capacity was only 11 percent compared to Lot 1. Surprisingly, the discharge capacity on the high power DSC test was even better (by about 18 percent) with the 50/50 EMD/NiOOH blend than for Lot 3, with only NiOOH as the active cathode material. Lot 4 has a low cell 1500 mW DSC polarization, comparable to that of Lot 3 and much lower than Lot 1; this low cell polarization is believed responsible for the improved high power discharge capacity of Lot 4, by enabling the cell to more effectively utilize the increased (versus Lot 3) cathode capacity to provide improved high power discharge capacity.

### EXAMPLE 4

Commercially available R6 size alkaline cells with zinc negative electrodes and positive electrodes containing EMD and/or NiOOH were obtained, and samples of each were analyzed, discharged and tested for polarization. The results (approximate) are summarized in Table 4.

TABLE 4

| | Lot 6 | Lot 7 | Lot 8 | Lot 9 |
|---|---|---|---|---|
| Manufacturer | A | B | C | D |
| EMD/NiOOH (by wt) | 50/50 | 50/50 | 50/50 | 0/100 |
| cathode molding process | ring | ring | ring | ring |
| low rate discharge capacity | 2282 | 2194 | 2510 | 1855 |
| (mAh) | | | | |
| high power discharge capacity | 618 | 495 | 533 | 425 |
| (mAh) | | | | |
| ohmic resistance (mΩ) | 107 | 101 | 117 | 116 |
| ohmic polarization (mV) | 112 | 106 | 123 | 125 |
| activation polarization (mV) | 22 | 22 | 16 | 19 |
| concentration polarization (mA) | 139 | 151 | 134 | 154 |
| total cell polarization (mV) | 272 | 279 | 273 | 298 |

Lot 9, with only NiOOH as the active cathode material, has a low discharge capacity on both low rate discharge and the high power 1500 mW DSC test. Lots 6 through 8, with EMD/NiOOH blends, have higher discharge capacities than Lot 9 on both the low rate discharge test and the high power discharge test. However, Lots 6 through 8 are deficient to cells according to the present invention, as represented by Lots 4 and 5. This is particularly evident on the high power discharge test, where the best of Lots 6 through 8 has a discharge capacity 45 percent lower than Lot 4. Lots 6 through 8 also have cell 1500 mW DSC polarization values substantially higher (28 to 32 percent) than Lot 4, with the differences in 1500 mW DSC ohmic polarization values being even greater.

### EXAMPLE 5

R03 size alkaline cells were made with only EMD (Lot 10), only NiOOH (Lot 11) and EMD plus NiOOH (Lot 12) as the active material, using the same types of materials and processes used for Lots 1-5. Features of Lots 10, 11 and 12 are shown in Table 5.

TABLE 5

| | Lot 10 | | Lot 11 | | Lot 12 | |
|---|---|---|---|---|---|---|
| Cathode solids mixture: | | | | | | |
| EMD | 94.80 | wt % | 0.0 | wt % | 47.07 | wt % |
| NiOOH | 0.0 | wt % | 94.77 | wt % | 47.07 | wt % |
| graphite | 4.74 | wt % | 4.76 | wt % | 4.76 | wt % |
| binder | 0.47 | wt % | 0.47 | wt % | 0.47 | wt % |
| EMD/NiOOH (by wt) | 100/0 | | 0/100 | | 50/50 | |
| active material/graphite (by wt) | 20/1 | | 20/1 | | 20/1 | |
| Cathode solids mixture quantity (dry) | 4.89 | g | 5.00 | g | 4.95 | g |
| Cathode mixture quantity (wet) | 5.44 | g | 5.44 | g | 5.45 | g |
| Cathode forming process | ring molded | | ring molded | | ring molded | |
| Cathode dimensions (final): | | | | | | |
| outside diameter | 9.70 | mm | 9.70 | mm | 9.70 | mm |
| inside diameter | 6.48 | mm | 6.48 | mm | 6.48 | mm |
| height | 38.25 | mm | 38.25 | mm | 38.25 | mm |
| volume | 1.57 | cm³ | 1.57 | cm³ | 1.57 | cm³ |
| Cathode porosity (final) | 26.2% | | 20.6% | | 23.3% | |
| Cathode resistivity (final) | 1.7 | ohm-cm | — | | 1.0 | ohm-cm |
| Cathode capacity | 1320 | mAh | 1067 | mAh | 1172 | mAh |
| Cathode volumetric capacity (final) | 842 | mAh/cm³ | 680 | mAh/cm³ | 747 | mAh/cm³ |
| Cathode gravimetric capacity (dry) | 243 | mAh/g | 196 | mAh/g | 215 | mAh/g |
| Anode composition (pre-assembly): | | | | | | |
| zinc | 67.00 | wt % | 61.00 | wt % | 64.02 | wt % |
| electrolyte solution | 32.54 | wt % | 38.45 | wt % | 35.48 | wt % |
| gellant | 0.46 | wt % | 0.55 | wt % | 0.50 | wt % |
| Zinc quantity | 1.97 | g | 1.62 | g | 1.79 | g |
| Anode capacity | 1615 | mAh/g | 1331 | mAh/g | 1467 | mAh/g |
| Anode porosity (final) | 72.7% | | 77.5% | | 75.2% | |
| Anode resistivity (final) | 3.7 | mohm-cm | 3.7 | mohm-cm | 3.7 | mohm-cm |
| Electrolyte (final - total cell): | | | | | | |
| water | 63.8 | wt % | 63.7 | wt % | 63.7 | wt % |
| KOH | 35.6 | wt % | 35.7 | wt % | 35.7 | wt % |

| | | | |
|---|---|---|---|
| A/C ratio | 1.22/1 | 1.25/1 | 1.25/1 |

### EXAMPLE 6

Cells from each of Lots 10 through 12 were discharged on a high power discharge test at room temperature. The high power discharge test was the 1200 mW DSC test described above. Cells from each lot were also tested to determine their 1200 mW DSC polarization, concentration polarization, activation polarization, ohmic polarization and ohmic resistance. The results are summarized in Table 6. The low rate discharge capacity was not determined by testing, but the cathode capacity provides an approximation of the expected low rate discharge capacity.

TABLE 6

| | Lot 10 | Lot 11 | Lot 12 |
|---|---|---|---|
| EMD/NiOOH | 100/0 | 0/100 | 50/50 |
| (by weight) | | | |
| cathode molding process | ring | ring | ring |
| cathode capacity (mAh) | 1320 | 1067 | 1172 |
| high power discharge capacity | 200 | 328 | 456 |
| (mAh) | | | |
| high power discharge efficiency | 15 | 31 | 39 |
| (%) | | | |
| ohmic resistance (mΩ) | 68 | 83 | 67 |
| ohmic polarization (mV) | 59 | 61 | 50 |
| activation polarization (mV) | 12 | 19 | 13 |
| concentration polarization (mA) | 175 | 133 | 147 |
| total cell polarization (mV) | 246 | 213 | 209 |

As in Example 3, replacing EMD with NiOOH as the active material increased the high power (DSC test) discharge capacity substantially but resulted in a reduced the low rate discharge capacity. By using a 50/50 blend of EMD/NiOOH as the cathode active material, the reduction in low rate capacity compared that with a 100 percent EMD active material was much less, and the high power discharge capacity was even higher than with a 100 percent NiOOH active material. The total cell polarization, ohmic polarization and ohmic resistance for Lot 12 are lower than those for Lot 11, enabling more effective use of the increased cathode capacity relative to Lot 11 to provide increased high power discharge capacity.

It will be understood by those who practice the invention and those skilled in the art that various modifications and improvements may be made to the invention without departing from the spirit of the disclose concept. The scope of protection afforded is to be determined by the claims and by the breadth of interpretation allowed by law.

The invention claimed is:

1. An electrochemical battery cell comprising a positive electrode, a negative electrode, a separator between the positive and negative electrodes and an electrolyte disposed within a housing; wherein:
the positive electrode comprises a formed body comprising a mixture of solids including manganese dioxide and nickel oxyhydroxide in a ratio of 10/90 to 90/10 by weight;
the negative electrode comprises a mixture including zinc and is disposed within one or more cavities within the positive electrode body;
when the positive electrode body comprises a single ring and has a volume of 3.3 to 4.6 cm³, the cell has a 1500 mW DSC polarization value of 100 to 310 mV;
when the positive electrode body comprises a single ring and has volume of 1.4 to 2.0 cm³, the cell has a 1200 mW DSC polarization value of 100 to 310 mV;
when the positive electrode body comprises a stack of two or more rings and has a volume of 3.3 to 4.6 cm³, the cell has a 1500 mW DSC polarization value of 100 to 240 mV; and
when the positive electrode body comprises a stack of two or more rings and has a volume of 1.4 to 2.0 cm³, the cell has a 1200 mW DSC polarization value of 100 to 240 mV.

2. The battery cell of claim 1, wherein the weight ratio of manganese dioxide to nickel oxyhydroxide is 20/80 to 80/20.

3. The battery cell of claim 2, wherein the weight ratio of manganese dioxide to nickel oxyhydroxide is 40/60 to 70/30.

4. The battery cell of claim 1, wherein the positive electrode body has an electrical resistivity of 0.6 to 1.6 ohm-cm.

5. The battery cell of claim 4, wherein the positive electrode solids mixture further includes 3 to 10 weight percent graphite.

6. The battery cell of claim 5, wherein the positive electrode solids mixture further includes 4 to 8 weight percent graphite.

7. The battery cell of claim 6, wherein the positive electrode solids mixture further includes 5.5 to 6 weight percent graphite.

8. The battery cell of claim 4, wherein the positive electrode solids mixture further includes graphite, and when the ratio of the combined weights of the manganese dioxide and the nickel oxyhydroxide to the weight of the graphite is equal to or greater than 30/1, all of the graphite is expanded graphite.

9. The battery cell of claim 4, wherein the positive electrode mixture has a porosity of 20 to 28 volume percent.

10. The battery cell of claim 4, wherein the positive electrode body has a porosity of 20 to 25 volume percent.

11. The battery cell of claim 1, wherein the negative electrode has an electrical resistivity of 3.5 to 3.8 milliohm-cm.

12. The battery cell of claim 11, wherein the negative electrode comprises 62 to 73 weight percent zinc.

13. The battery cell of claim 12, wherein the negative electrode comprises 62 to 70 weight percent zinc.

14. The battery cell of claim 11, wherein the negative electrode has a porosity of 70 to 78 volume percent.

15. The battery cell of claim 14, wherein the negative electrode has a porosity of 70 to 76 volume percent.

16. The battery cell of claim 1, wherein the zinc comprises a zinc alloy comprising bismuth, indium and aluminum.

17. The battery cell of claim 16, wherein the zinc is in the form of particles with an median particle size of 100 to 130 μm.

18. The battery cell of claim 17, wherein the median particle size is 110 to 120 μm.

19. The battery cell of claim 1, wherein the zinc comprises flakes.

20. The battery cell of claim 1, wherein the electrolyte comprises an aqueous solution of potassium hydroxide.

21. The battery cell of claim 20, wherein the electrolyte comprises at least 26 to less than 40 weight percent potassium hydroxide.

22. The battery cell of claim 21, wherein the electrolyte comprises 28 to 38 weight percent potassium hydroxide.

23. The battery cell of claim 22, wherein the electrolyte comprises 32 to 36 weight percent potassium hydroxide.

24. The battery cell of claim 1, wherein the positive electrode has a capacity, the negative electrode capacity and a ratio of the positive electrode capacity to the negative electrode capacity is 1.0/1 to 1.4/1.

25. The battery cell of claim 1, wherein the positive electrode has a capacity, the negative electrode capacity and a ratio of the positive electrode capacity to the negative electrode capacity is 1.0/1 to 1.35/1.

26. The battery cell of claim 1, wherein the cell is a primary cell.

27. The battery cell of claim 1, wherein the housing is hermetically sealed.

28. The battery cell of claim 1, wherein the cell is a cylindrical cell.

29. The battery cell of claim 1, wherein the cell is a prismatic cell.

30. An electrochemical battery cell comprising a positive electrode, a negative electrode, a separator between the positive and negative electrodes and an electrolyte disposed within a housing; wherein:
the positive electrode comprises a formed body comprising a mixture of solids including manganese dioxide and nickel oxyhydroxide in a ratio of 10/90 to 90/10 by weight;
the negative electrode comprises a mixture including zinc and is disposed within one or more cavities within the positive electrode body;
the positive electrode body comprises a single ring and has a volume of 3.3 to 4.6 cm³;
the cell has a 1500 mW DSC polarization value of 100 to 310 mV; and
the cell has a discharge capacity of 2500 to 2800 mAh when continuously cycled to 0.4 volt, where each cycle consists of 30 minutes at 50 mA followed by 2 hours open circuit.

31. The battery cell of claim 30, wherein the cell has a discharge capacity of 2600 to 2800 mAh when continuously cycled to 0.4 volt, where each cycle consists of 30 minutes at 50 mA followed by 2 hours open circuit.

32. The battery cell of claim 30, wherein the cell has a discharge capacity of 700 to 1400 when cycled continuously to 1.05 volt, where each cycle consists of ten sets of alternating pulses of 1500 mW for 10 seconds then 650 mW for 28 seconds, followed by 55 minutes open circuit.

33. The battery cell of claim 30, wherein the weight ratio of manganese dioxide to nickel oxyhydroxide is 40/60 to 80/20, the positive electrode has a capacity, the negative electrode capacity and a ratio of the positive electrode capacity to the negative electrode capacity is 1.3/1 to 1.35/1.

34. The battery cell of claim 30, wherein the cell has a 1500 mW DSC polarization value of 100 to 300 mV.

35. The battery cell of claim 30, wherein the cell has a 1500 mW DSC ohmic resistance value of 75 to 130 mΩ.

36. The battery cell of claim 30, wherein the positive electrode body has a solids packing of 71 to 74 volume percent.

37. The battery cell of claim 30, wherein the positive electrode body has a weight ratio of active material to graphite of 10/1 to 20/1.

38. The battery cell of claim 30, wherein the cell is an R6 size cell.

39. An electrochemical battery cell comprising a positive electrode, a negative electrode, a separator between the positive and negative electrodes and an electrolyte disposed within a housing; wherein:
the positive electrode comprises a formed body comprising a mixture of solids including manganese dioxide and nickel oxyhydroxide in a ratio of 10/90 to 90/10 by weight;
the negative electrode comprises a mixture including zinc and is disposed within one or more cavities within the positive electrode body;
the positive electrode body comprises a single ring and has a volume of 1.4 to 2.0 cm³;
the cell has a 1200 mW DSC polarization value of 100 to 310 mV; and
the cell has a discharge capacity of 1050 to 1250 mAh when continuously cycled to 0.4 volt, where each cycle consists of 30 minutes at 50 mA followed by 2 hours open circuit.

40. The battery cell of claim 39, wherein the cell has a discharge capacity of 1100 to 1250 mAh when continuously cycled to 0.4 volt, where each cycle consists of 30 minutes at 50 mA followed by 2 hours open circuit.

41. The battery cell of claim 39, wherein the cell has a discharge capacity of 250 to 650 when cycled continuously to 1.05 volt, where each cycle consists of ten sets of alternating pulses of 1200 mW for 10 seconds then 650 mW for 28 seconds, followed by 55 minutes open circuit.

42. The battery cell of claim 39, wherein the weight ratio of manganese dioxide to nickel oxyhydroxide is 40/60 to 80/20, the positive electrode has a capacity, the negative electrode capacity and a ratio of the positive electrode capacity to the negative electrode capacity is 1.3/1 to 1.35/1.

43. The battery cell of claim 39, wherein the cell has a 1200 mW DSC polarization value of 80 to 140 mΩ.

44. The battery cell of claim 43, wherein the cell has a 1200 mW DSC ohmic resistance value of 75 to 130 mΩ.

45. The battery cell of claim 39, wherein the positive electrode body has a solids packing of 71 to 74 volume percent.

46. The battery cell of claim 39, wherein the positive electrode body has a weight ratio of active material to graphite of 10/1 to 20/1.

47. The battery cell of claim 39, wherein the cell is an R03 size cell.

48. An electrochemical battery cell comprising a positive electrode, a negative electrode, a separator between the positive and negative electrodes and an electrolyte disposed within a housing; wherein:
the positive electrode comprises a formed body comprising a mixture of solids including manganese dioxide and nickel oxyhydroxide in a ratio of 10/90 to 90/10 by weight;
the negative electrode comprises a mixture including zinc and is disposed within one or more cavities within the positive electrode body;
the positive electrode body comprises a stack of two or more rings and has a volume of 3.3 to 4.6 cm³;
the cell has a 1500 mW DSC polarization value of 100 to 240 mV; and
the cell has a discharge capacity of 2600 to 2950 mAh when continuously cycled to 0.4 volt, where each cycle consists of 30 minutes at 50 mA followed by 2 hours open circuit.

49. The battery cell of claim 48, wherein the cell has a discharge capacity of 2700 to 2950 mAh when continuously cycled to 0.4 volt, where each cycle consists of 30 minutes at 50 mA followed by 2 hours open circuit.

50. The battery cell of claim 48, wherein the cell has a discharge capacity of 800 to 1500 when cycled continuously to 1.05 volt, where each cycle consists of ten sets of alternating pulses of 1500 mW for 10 seconds then 650 mW for 28 seconds, followed by 55 minutes open circuit.

51. The battery cell of claim 48, wherein the weight ratio of manganese dioxide to nickel oxyhydroxide is 40/60 to 80/20, the positive electrode has a capacity, the negative electrode capacity and a ratio of the positive electrode capacity to the negative electrode capacity is 1.15/1 to 1.25/1.

52. The battery cell of claim 48, wherein the cell has a 1500 mW DSC polarization value of 100 to 225 mV.

53. The battery cell of claim 52, wherein the cell has a 1500 mW DSC ohmic resistance value of 40 to 90 mΩ.

54. The battery cell of claim 48, wherein the positive electrode body has a solids packing of 77 to 83 volume percent.

55. The battery cell of claim 48, wherein the positive electrode body has a weight ratio of active material to graphite of 15/1 to 30/1.

56. The battery cell of claim 48, wherein the cell is an R6 size cell.

57. The battery cell of claim 48, wherein the formed cathode body has a capacity density defined by the formula (a x+b), where a is 1.8 mA/cm³ and b is 553 to 698 mAh/cm³.

58. An electrochemical battery cell comprising a positive electrode, a negative electrode, a separator between the positive and negative electrodes and an electrolyte disposed within a housing; wherein:
the positive electrode comprises a formed body comprising a mixture of solids including manganese dioxide and nickel oxyhydroxide in a ratio of 10/90 to 90/10 by weight;
the negative electrode comprises a mixture including zinc and is disposed within one or more cavities within the positive electrode body;
the positive electrode body comprises a stack of two or more rings and has a volume of 1.4 to 2.0 cm³;
the cell has a 1200 mW DSC polarization value of 100 to 240 mV; and
the cell has a discharge capacity of 1100 to 1300 mAh when continuously cycled to 0.4 volt, where each cycle consists of 30 minutes at 50 mA followed by 2 hours open circuit.

59. The battery cell of claim 58, wherein the cell has a discharge capacity of 1150 to 1300 mAh when continuously cycled to 0.4 volt, where each cycle consists of 30 minutes at 50 mA followed by 2 hours open circuit.

60. The battery cell of claim 58, wherein the cell has a discharge capacity of 300 to 700 mAh when cycled continuously to 1.05 volt, where each cycle consists of ten sets of alternating pulses of 1200 mW for 10 seconds then 650 mW for 28 seconds, followed by 55 minutes open circuit.

61. The battery cell of claim 58, wherein the weight ratio of manganese dioxide to nickel oxyhydroxide is 40/60 to 80/20, the positive electrode has a capacity, the negative electrode capacity and a ratio of the positive electrode capacity to the negative electrode capacity is 1.15/1 to 1.25/1.

62. The battery cell of claim 58, wherein the cell has a 1200 mW DSC polarization value of 100 to 225 mV.

63. The battery cell of claim 62, wherein the cell has a 1200 mW DSC ohmic resistance value of 55 to 110 mΩ.

64. The battery cell of claim 58, wherein the positive electrode body has a solids packing of 77 to 83 volume percent.

65. The battery cell of claim 58, wherein the positive electrode body has a weight ratio of active material to graphite of 15/1 to 30/1.

66. The battery cell of claim 58, wherein the cell is an R03 size cell.

67. The battery cell of claim 58, wherein the formed cathode body has a capacity density defined by the formula (a x+b), where a is 1.8 mA/cm³ and b is 553 to 698 mAh/cm³.

68. An electrochemical battery cell comprising a positive electrode, a negative electrode, a separator between the positive and negative electrodes and an electrolyte disposed within a housing; wherein:
the positive electrode:
comprises a hollow cylindrical body;
comprises a mixture of solids including manganese dioxide, nickel oxyhydroxide and graphite, where the ratio of manganese dioxide to nickel oxyhydroxide is 40/60 to 70/30 by weight and the ratio of the combination of manganese dioxide and nickel oxyhydroxide to graphite is 15/1 to 30/1 by weight;
has a porosity of 17 to 23 volume percent; and
has an electrical resistivity of 0.6 to 1.6 ohm-cm;
the negative electrode:
is disposed within a cylindrical cavity within the positive electrode body;
comprises a mixture including 62 to 70 weight percent zinc particles, the zinc being alloyed with bismuth, indium and aluminum, and the zinc particles having a median particle size of 110 to 120 μm;
has a porosity of 70 to 76 volume percent; and
has a resistivity of 3.5 to 3.8 milliohm-cm;
the positive and negative electrodes have electrode capacities and the ratio of the negative electrode capacity to the positive electrode capacity is 1.15/1 to 1.25/1; and
the electrolyte is an aqueous solution comprising 32 to 36 weight percent potassium hydroxide.

69. The battery cell of claim 68, wherein the cell is an R6 size cell and has:
a 1500 mW DSC polarization value of 100 to 225 mV;
a discharge capacity of 2600 to 2950 mAh when continuously cycled to 0.4 volt, where each cycle consists of 30 minutes at 50 mA followed by 2 hours open circuit; and
a discharge capacity of 800 to 1500 when cycled continuously to 1.05 volt, where each cycle consists of ten sets of alternating pulses of 1500 mW for 10 seconds then 650 mW for 28 seconds, followed by 55 minutes open circuit.

70. The battery cell of claim 68, wherein the cell is an R03 size cell and has:
a 1200 mW DSC polarization value of 100 to 225 mV;
a discharge capacity of 1100 to 1300 mAh when continuously cycled to 0.4 volt, where each cycle consists of 30 minutes at 50 mA followed by 2 hours open circuit; and
a discharge capacity of 300 to 700 mAh when cycled continuously to 1.05 volt, where each cycle consists of ten sets of alternating pulses of 1200 mW for 10 seconds then 650 mW for 28 seconds, followed by 55 minutes open circuit.

71. The battery cell of claim 68, wherein the formed cathode body comprises a stack of two or more rings and has a capacity density defined by the formula (ax+b), where a is 1.8 mA/cm³ and b is 553 to 698 mAh/cm³.
